(19) United States
(12) Patent Application Publication
(10) Pub. No.: US 2026/0103366 A1
(43) Pub. Date: Apr. 16, 2026

(54) AUTOMOTIVE BATTERY LIFTING DEVICE AND AUTOMOTIVE BATTERY LIFTING METHOD

(71) Applicant: Honda Motor Co., Ltd., Tokyo (JP)

(72) Inventors: Tomohisa KATAYAMA, Tokyo (JP); Tsukuru YAMAMURA, Tokyo (JP); Toru KUMAGAI, Tokyo (JP); Hiroaki ENDOH, Tokyo (JP); Shingo ITOH, Tokyo (JP); Shun OTSUKA, Tokyo (JP); Hiromu SUKEGAWA, Tokyo (JP)

(73) Assignee: Honda Motor Co., Ltd., Tokyo (JP)

(21) Appl. No.: 19/302,071

(22) Filed: Aug. 17, 2025

(30) Foreign Application Priority Data
Oct. 11, 2024 (CN) 202411413088.X

(51) Int. Cl. B66F 7/26; B60L 50/60; B60S 5/06; B66F 7/20; B66F 7/22

(52) U.S. Cl. CPC B66F 7/26; B60S 5/06; B66F 7/20; B66F 7/22; B60L 50/60

(57) ABSTRACT

An automotive battery lifting device is used for assembling a battery unit to the vehicle body from a bottom surface side of the vehicle body, including: a battery carrier tray having a carrier surface for mounting the battery unit; a lifting mechanism, the lifting mechanism being used for moving the battery carrier tray along a lifting direction; and a plurality of cylinders for adjusting a horizontal inclination of the carrier surface of the battery carrier tray, when the lifting mechanism raises the battery carrier tray and the battery unit or the battery carrier tray contacts the vehicle body at a first position, air in at least the cylinder close to the first position is discharged.

### CROSS-REFERENCE TO RELATED APPLICATION

This application claims the priority benefit of China application serial no. 202411413088.X, filed on Oct. 11, 2024. The entirety of the above-mentioned patent application is hereby incorporated by reference herein and made a part of this specification.

### BACKGROUND

### Technical Field

The present invention relates to an automotive battery lifting device and an automotive battery lifting method.

### Related Art

In recent years, research and development related to secondary batteries that contribute to energy efficiency are being conducted to ensure access to more affordable, reliable, sustainable, and advanced energy for more people.

Unlike primary batteries that cannot be recharged, secondary batteries refer to batteries that may be charged and discharged, and secondary batteries are being used as power sources for energy storage systems (ESS), electric vehicles (EV) or hybrid electric vehicles (HEV), and small high-tech electronic devices (such as mobile phones, Personal Digital Assistants (PDA), and notebook computers). Specifically, in technology related to automotive secondary batteries, how to reliably assemble secondary batteries on the vehicle body during the vehicle assembly process is an important issue.

In general conditions, when fixing an object to a vehicle body, it is fixed to the vehicle body by axial force during tightening and brought into close contact. However, since a current single secondary battery (battery cell) cannot provide sufficient output to drive an electric vehicle, in order to use secondary batteries as an energy source for electric vehicles (for example, battery modules should be configured with multiple lithium-ion battery cells connected in series and/or parallel), and typically, a battery pack is configured to include a Battery Management System (BMS), cooling system, Battery Disconnection Unit (BDU), electrical wiring cables, etc. for connecting battery modules in series and functionally maintaining the battery modules. Consequently, an automotive battery unit with heavy overall weight and large dimensions is formed, which also results in an increase in the overall weight of the fixture for battery unit mounting, making the payload required for the lift used to raise and lower the automotive battery unit for assembly extremely large. In the above condition, when attempting to bring the vehicle body and automotive battery unit into close contact, the overall weight of the vehicle combining the vehicle body and automotive battery unit will be applied to the lift, which may cause the lift to experience abnormal overload conditions with risk of damage, or alternatively, to avoid the risk of damage, the lift would be required to have extremely large overload capability.

In the prior art, prior art document 1 discloses a battery unit assembly device that, when assembling the battery unit, provides springs as elastic members between a work table for mounting the battery unit and a lift. The springs generate elasticity to maintain the horizontal orientation of the carrier surface of the work table for battery unit mounting, and guide components are provided on the work table for mounting the battery unit. Based on contact between the guide components, the carrier surface on the work table may be reliably made substantially parallel to the bottom surface of the vehicle. Thus, the battery unit assembly device of prior art document 1 tilts the carrier surface for battery unit mounting substantially parallel to the bottom surface of the vehicle, so that the battery unit do not contact the vehicle, thereby preventing strong loads from acting on a portion of the battery unit, enabling easy and reliable assembly of battery unit to the vehicle with a simple structure even when the vehicle body is tilted.

However, in prior art document 1, the contact between the reference guide and the general guide in the guide component also has a risk of causing wear to the general guide, and if the general guide becomes worn, the battery unit mounted on the carrier surface of the work table will be installed in a condition where it is tilted relative to the bottom surface of the vehicle, which will still cause a portion of the battery unit to bear additional load. Additionally, when assembling the battery unit, since one side of the battery unit (the relatively lower side in the vertical direction) will be subjected to pressure from spring reaction force, there is also a risk of spring deterioration and battery unit damage.

The present case aims to achieve reliable assembly of the automotive battery unit to vehicles in order to solve the aforementioned problems. Furthermore, it contributes to energy efficiency.

### PRIOR ART LITERATURE

### Patent Document

[Patent Document 1] Japanese Patent Publication No. 6048153

### SUMMARY

The present invention provides an automotive battery lifting device and an automotive battery lifting method with good reliability.

The present invention provides an automotive battery lifting device for assembling a battery unit to a vehicle body from a bottom surface side of the vehicle body, including: a battery carrier tray having a carrier surface for mounting the battery unit; a lifting mechanism for moving the battery carrier tray along a lifting direction; and a plurality of cylinders for adjusting a horizontal inclination of the carrier surface of the battery carrier tray, wherein when the lifting mechanism raises the battery carrier tray and the battery unit or the battery carrier tray contacts the vehicle body at a first position, air in at least the cylinder close to the first position is discharged.

The present invention provides an automotive battery lifting method, including: a pressure setting step, setting a support pressure and a release pressure for a plurality of cylinders disposed between a battery carrier tray and a lifting mechanism and corresponding to a battery unit; a battery support step, utilizing the support pressure to support the battery carrier tray having the battery unit mounted thereon; a lifting step, utilizing the lifting mechanism to lift the battery carrier tray, and in the lifting step, the lifting mechanism raises the battery carrier tray until air pressure of all the cylinders exceeds the set release pressure, and all the plurality of cylinders are in an exhaust state.

In an embodiment of the present invention, the battery carrier tray is supported by a support pressure set by each of the cylinders, and each of the cylinders is respectively set with a release pressure greater than the support pressure, when air pressure in any of the cylinders reaches its set release pressure, air in any of the cylinders is discharged, so that air pressure in any of the cylinders is below its set release pressure.

In an embodiment of the present invention, when the air pressure of all of the plurality of cylinders exceeds the set release pressure due to contact, the lifting mechanism raises the battery carrier tray until all of the plurality of cylinders are in an exhaust state.

In an embodiment of the present invention, the release pressure of the cylinder when the battery carrier tray is raised by the lifting mechanism is set to be lower than the release pressure of the cylinder before the battery carrier tray is raised by the lifting mechanism.

In an embodiment of the present invention, the automotive battery lifting device further includes: a detection unit for detecting whether contact condition occurs between the battery unit or the battery carrier tray and the vehicle body, and based on the contact condition, controlling discharge of air in the cylinder.

In an embodiment of the present invention, the automotive battery lifting device further includes: a sliding unit disposed between the cylinders and the lifting mechanism, the sliding unit enabling the battery unit and the battery carrier tray to slide in a direction perpendicular to the lifting direction.

In an embodiment of the present invention, the automotive battery lifting device further includes: a locating pin for fixing the battery unit on the carrier surface of the battery carrier tray, and the battery carrier tray has a sliding mechanism capable of adjusting the locating pin on a plane perpendicular to the lifting direction.

Based on the above, in the automotive battery lifting device and automotive battery lifting method of the embodiment of the present invention, the battery carrier tray for battery unit mounting and the lift that raises and lowers the battery carrier tray relative to the vehicle are supported by cylinders. The cylinders perform assembly of the battery unit in a manner that tilts the carrier surface at a specified inclination relative to the bottom surface of the vehicle in response to contact between the battery unit or the battery carrier tray and the bottom surface of the vehicle. Here, the specified inclination refers to an inclination suitable for fixing the battery unit to the vehicle. Therefore, even when the vehicle is tilted, the battery unit may be easily assembled to the vehicle with a simple structure. Moreover, the automotive battery lifting device may prevent load increase through a simple configuration by using the pressure increased during contact as a trigger mechanism for whether to discharge air in the cylinder, thereby enabling reduction of the total load at the contact point, thus enabling protection of the battery unit, and further enabling the lifting mechanism to achieve overload capability for handling the load of the battery unit, fixture weight, and reaction force of the floating mechanism, but without bearing loads exceeding necessary weight such as greater than the vehicle weight, preventing overload abnormality conditions. Furthermore, since the mounting surface of the battery unit and the bottom surface of the vehicle body are also tilted in a substantially parallel manner, axial force is not lost when fixing the battery unit and vehicle body, and the battery unit may be more firmly fixed to the vehicle body. In addition, through control of air pressure in the cylinder, the automotive battery lifting device may more rapidly change the inclination of the battery carrier tray, thereby enabling improvement of the mounting speed of the battery unit.

To make the above features and advantages of the present invention more obvious and understandable, embodiments are specifically provided below and described in detail with accompanying drawings as follows.

### BRIEF DESCRIPTION OF THE DRAWINGS

FIG. 1A is an exploded schematic diagram of an automotive battery lifting device according to an embodiment of the present invention.

FIG. 1B is a structural schematic diagram of the automotive battery lifting device shown in FIG. 1A.

FIG. 2A and FIG. 2B are dimension schematic diagrams of battery units of different dimensions, respectively.

FIG. 2C and FIG. 2D are a top view and a side view, respectively, when the battery unit is positioned on the battery carrier tray.

FIG. 2E is a structural schematic diagram when the battery unit is positioned in the automotive battery lifting device shown in FIG. 1B.

FIG. 3 to FIG. 6 are schematic diagrams when the battery unit is assembled to the vehicle body from the bottom surface side of the vehicle body.

FIG. 7A is a structural schematic diagram of the cylinder.

FIG. 7B and FIG. 7C are schematic diagrams of pressure changes of air pressure in the cylinder when assembling the battery unit to the vehicle body.

FIG. 8A is a top view schematic diagram of the position of the floating mechanism on the battery unit.

FIG. 8B and FIG. 8C are side view schematic diagrams of the floating mechanism and battery unit when viewed from different sides.

### DESCRIPTION OF THE EMBODIMENTS

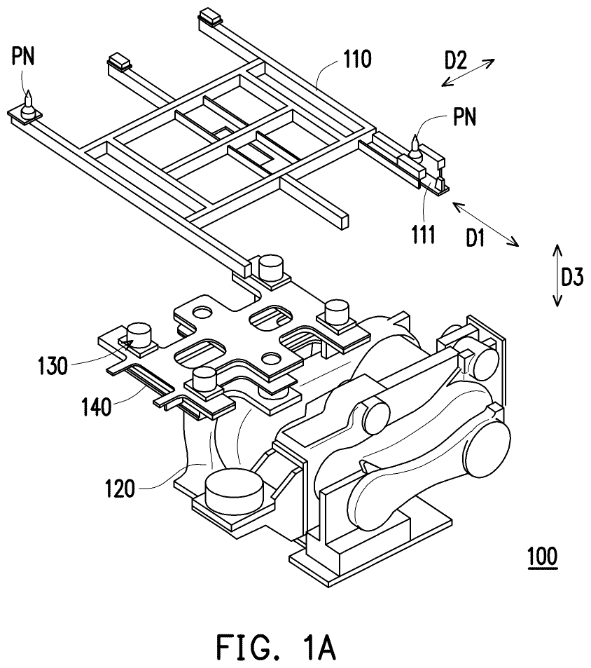

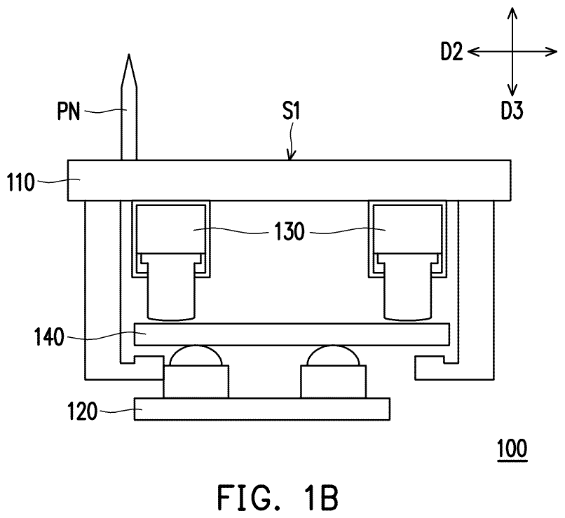

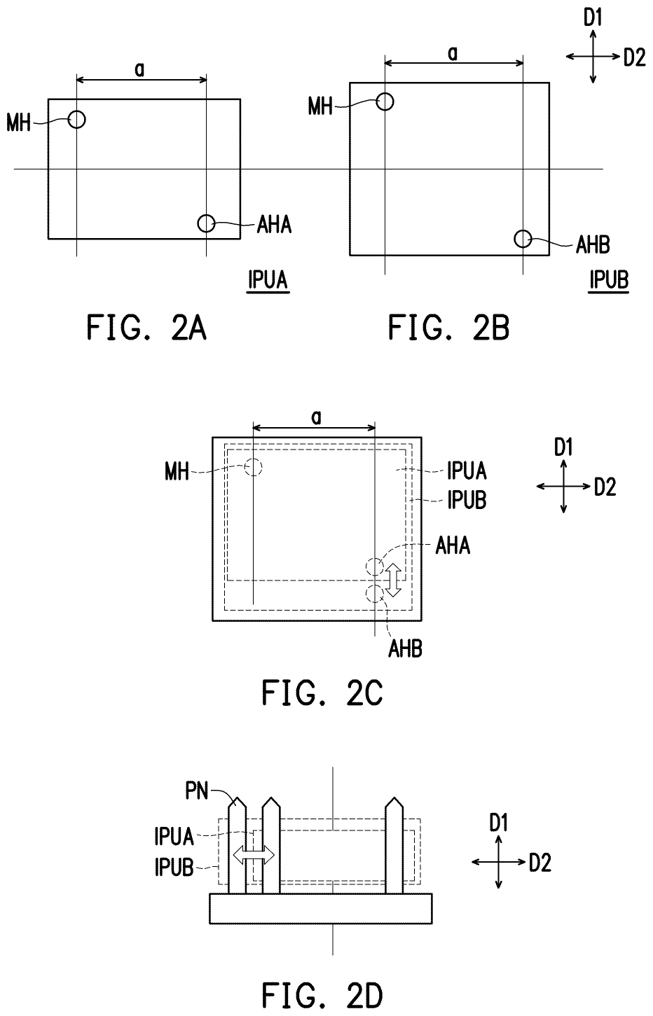

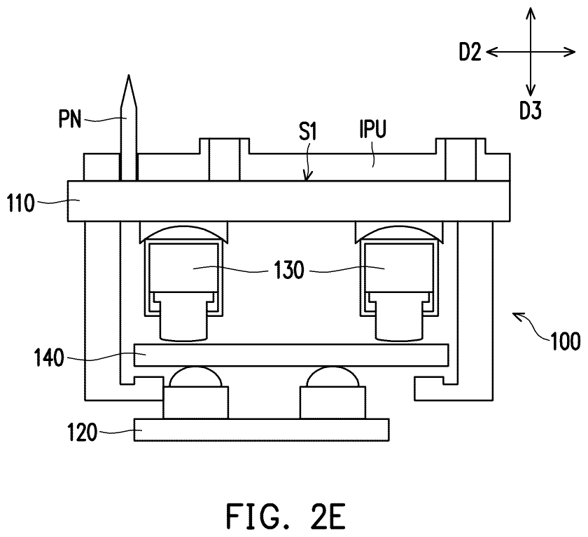

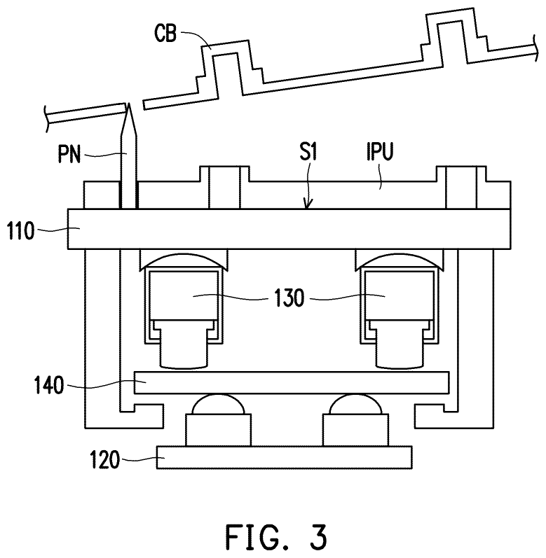

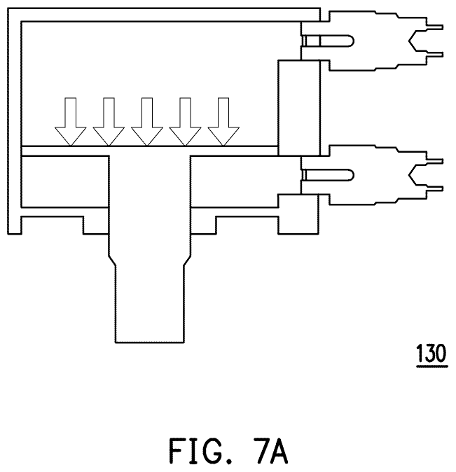

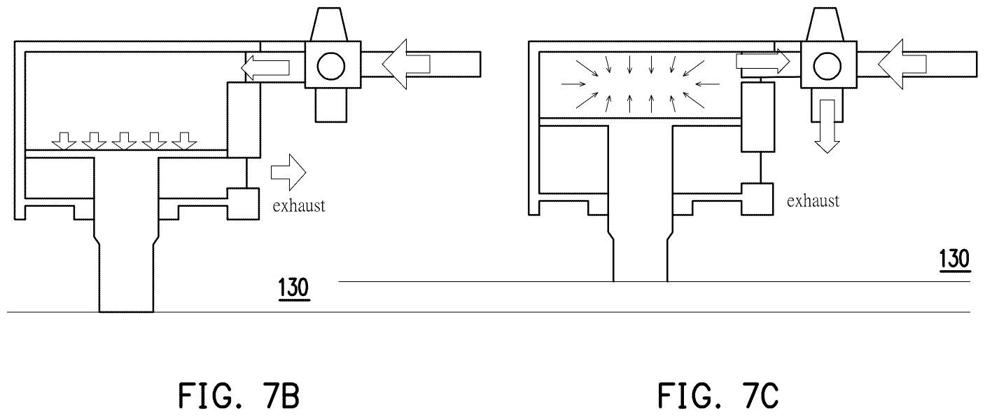

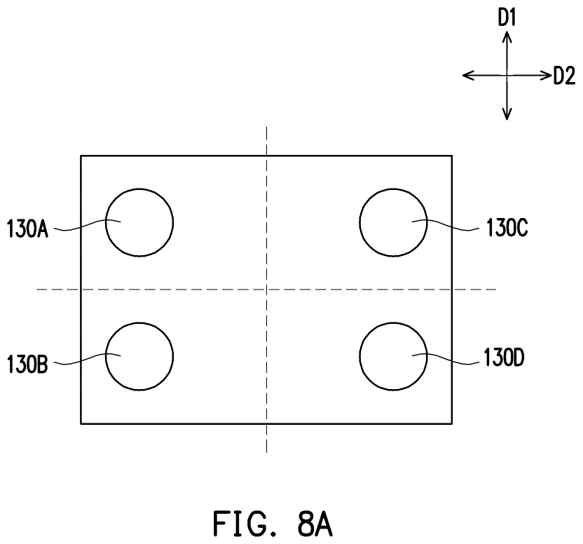

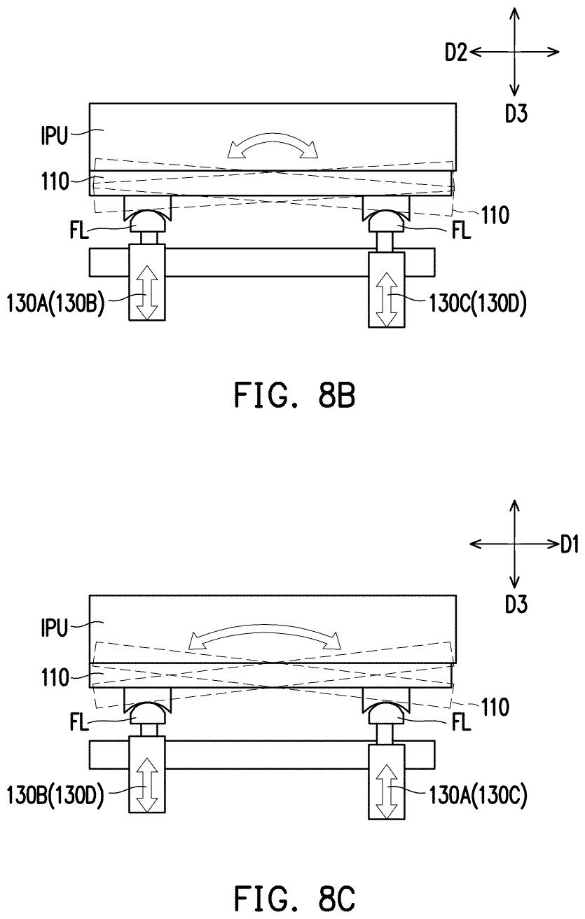

FIG. 1A is an exploded schematic diagram of an automotive battery lifting device according to an embodiment of the present invention; FIG. 1B is a structural schematic diagram of the automotive battery lifting device shown in FIG. 1A; FIG. 2A and FIG. 2B are dimensional schematic diagrams of battery units of different dimensions respectively; FIG. 2C and FIG. 2D are a top view and a side view respectively when the battery unit is positioned on the battery carrier tray; FIG. 3 to FIG. 6 are schematic diagrams when assembling the battery unit to the vehicle body from the bottom side of the vehicle body; FIG. 7A is a structural schematic diagram of the cylinder; FIG. 7B and FIG. 7C are schematic diagrams of pressure changes of air pressure in the cylinder when assembling the battery unit to the vehicle body; FIG. 8A is a top view schematic diagram of the position of the floating mechanism on the battery unit; FIG. 8B and FIG. 8C are side view schematic diagrams of the floating mechanism and the battery unit when viewed from different sides. In this specification, each direction in space is determined based on the lifting direction D3 of the lifting mechanism 120 of the automotive battery lifting device 100 and a plane perpendicular to the lifting direction D3. The following will explain the specific structure of the automotive battery lifting device 100 and each step of performing the automotive battery lifting method with reference to FIG. 1A to FIG. 8C.

Please refer to FIG. 1A to FIG. 2E. In this embodiment, the automotive battery lifting device 100 may be used to assemble the battery unit IPU to the vehicle body CB from the bottom side of the vehicle body CB, and the automotive battery lifting device 100 includes a battery carrier tray 110, a lifting mechanism 120, locating pins PN, a sliding unit 140, and multiple cylinders 130. Specifically, as shown in FIG. 1A and FIG. 1B, in this embodiment, the battery carrier tray 110 has a carrier surface S1 for mounting the battery unit IPU. The lifting mechanism 120 is used to move the battery carrier tray 110 along the lifting direction D3. Moreover, the locating pins PN are used to fix the battery unit IPU on the carrier surface S1 of the battery carrier tray 110, and the battery carrier tray 110 has a sliding mechanism 111 that may adjust the locating pins PN on a plane perpendicular to the lifting direction D3. Furthermore, as shown in FIG. 1A and FIG. 1B, in this embodiment, the sliding mechanism 111 may move one of the locating pins PN along the first direction D1 and the second direction D2 that are orthogonal to each other in a plane perpendicular to the lifting direction D3. Thus, through the configuration of the locating pins PN and the sliding mechanism 111, the locating pins PN may be used to position battery units IPU of different dimensions. For example, as shown in FIG. 2A and FIG. 2B, the battery unit IPUA in FIG. 2A and the battery unit IPUB in FIG. 2B have different dimensions. On the diagonals of the battery unit IPUA in FIG. 2A and the battery unit IPUB in FIG. 2B, there are respectively main reference holes MH and secondary reference holes AHA, AHB for the locating pins PN to pass through for fixing. Moreover, as shown in FIG. 2C and FIG. 2D, when fixing the battery unit IPUA in FIG. 2A or the battery unit IPUB in FIG. 2B on the carrier surface S1 of the battery carrier tray 110, one of the locating pins PN may be kept fixed after aligning with the main reference hole MH, and the sliding mechanism 111 moves the position of another locating pin PN to align it with the secondary reference hole AHA of the battery unit IPUA or the secondary reference hole AHB of the battery unit IPUB, and then performs the fixing of the battery unit IPUA in FIG. 2A or the battery unit IPUB in FIG. 2B with the battery carrier tray 110. Thus, as shown in FIG. 2E, the battery unit IPU, regardless of its dimension, may all be fixed on the carrier surface S1 of the battery carrier tray 110 through the locating pins PN.

Furthermore, the sliding unit 140 is disposed between the cylinder 130 and the lifting mechanism 120, and enables the battery unit IPU and the battery carrier tray 110 to slide in a direction perpendicular to the lifting direction D3, for adjusting the horizontal relative position of the battery unit IPU and the vehicle body CB when assembling the battery unit IPU to the vehicle body CB. On the other hand, in the present embodiment, the plurality of cylinders 130 may be used to adjust the horizontal inclination of the carrier surface S1 of the battery carrier tray 110, so that the battery unit IPU may be assembled to the vehicle body CB from the bottom surface side of the vehicle body CB regardless of how the vehicle body CB is tilted. The following will provide further explanation of the process of assembling the battery unit IPU to the vehicle body CB with reference to FIG. 3 to FIG. 8C.

Specifically, in the present embodiment, the automotive battery lifting device 100 may be used to perform the automotive battery lifting method shown in FIG. 3 to FIG. 6, wherein the automotive battery lifting method includes a pressure setting step, a battery support step, and a lifting step. Furthermore, in the pressure setting step of the present embodiment, the automotive battery lifting device 100 sets the supporting pressure and release pressure of the plurality of cylinders 130 disposed between the battery carrier tray 110 and the lifting mechanism 120 and corresponding to the battery unit IPU. In the battery support step of the present embodiment, the automotive battery lifting device 100 utilizes the supporting pressure to support the battery carrier tray 110 on which the battery unit IPU is installed. That is, as shown in FIG. 3 to FIG. 6, in the present embodiment, the battery carrier tray 110 is supported by the set supporting pressure of each cylinder 130.

Moreover, in the present embodiment, as shown in FIG. 7A to FIG. 7C, a release pressure may be set for each cylinder 130 respectively. When the air pressure in any cylinder 130 reaches its set release pressure, the air in any cylinder 130 may be discharged, so that the air pressure in any cylinder 130 is below its set release pressure. For example, in the present embodiment, the release pressure of each cylinder 130 is set to be greater than its support pressure respectively.

Thus, by setting the release pressure of each cylinder 130 to be greater than its support pressure, before the battery unit IPU or battery carrier tray 110 contacts the vehicle body CB, when the air pressure in each cylinder 130 has not yet reached its set release pressure, the automotive battery lifting device 100 will not discharge the air in the cylinder 130, and the air cannot escape. When the battery unit IPU or battery carrier tray 110 contacts the vehicle body CB, each cylinder 130 receives additional pressure caused by the weight of the vehicle body CB, which may cause the air pressure in the cylinder 130 to reach its set release pressure. At this time, as shown in FIG. 7B and FIG. 7C, the automotive battery lifting device 100 may correspondingly discharge the air in the cylinder 130, and thereby control the air pressure in each cylinder 130. Moreover, as shown in FIG. 8A to FIG. 8C, in the present embodiment, the lifting mechanism 120 has a floating mechanism FL. When the battery unit IPU or battery carrier tray 110 contacts the vehicle body CB, the floating mechanism FL is activated through the contact force, and may enable the vehicle body CB and battery unit IPU to maintain close contact. Thus, by using the pressure increased during contact as a trigger mechanism for whether to discharge the air in the cylinder 130, load increase may be prevented through simple configuration, thereby enabling reduction of the total load at the contact point, and further enabling protection of the battery unit IPU.

On the other hand, in the lifting step of the present embodiment, the automotive battery lifting device 100 utilizes the lifting mechanism 120 to lift the battery carrier tray 110. Moreover, in the present embodiment, the automotive battery lifting device 100 may set the release pressure of the cylinder 130 after the battery carrier tray 110 is raised by the lifting mechanism 120 to be lower than the release pressure of the cylinder 130 before the battery carrier tray 110 is raised by the lifting mechanism 120. In this manner, before raising the lifting mechanism 120, by increasing the release pressure of the cylinder 130, the cylinder 130 may not reach the threshold of its set release pressure due to acceleration and deceleration during movement of the lifting mechanism 120 and trigger the air in the cylinder 130 to be discharged, causing the space in the cylinder 130 to contract, thereby enabling the lifting mechanism 120 to move smoothly. Furthermore, by reducing the set value of the release pressure of the cylinder 130 after mounting the battery unit IPU and increasing the stroke of the cylinder 130, the initial load when the vehicle body CB, battery unit IPU, and battery carrier tray 110 contact may be suppressed.

For example, as shown in FIG. 3, in the present embodiment, when starting to assemble the battery unit IPU on the vehicle body CB, the cylinder 130 shown in FIG. 3 may discharge air inside the cylinder 130 through the manner shown in FIG. 7B, and thereby control the air pressure inside each cylinder 130, and thereby suppress the initial load when the vehicle body CB, the battery unit IPU, and the battery carrier tray 110 contact.

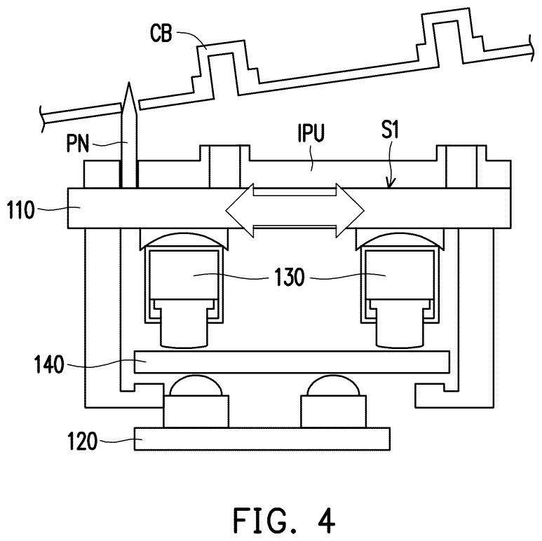

Next, as shown in FIG. 4, in the present embodiment, the sliding unit 140 enables the battery unit IPU and the battery carrier tray 110 to slide in a direction perpendicular to the lifting direction D3, for adjusting the horizontal relative position between the battery unit IPU and the vehicle body CB when assembling the battery unit IPU to the vehicle body CB. In this manner, the conical portion of the locating pin PN and the positioning hole of the vehicle body CB may be moved while in contact, thereby enabling correction of positional deviation when the locating pin PN is inserted into the vehicle body CB.

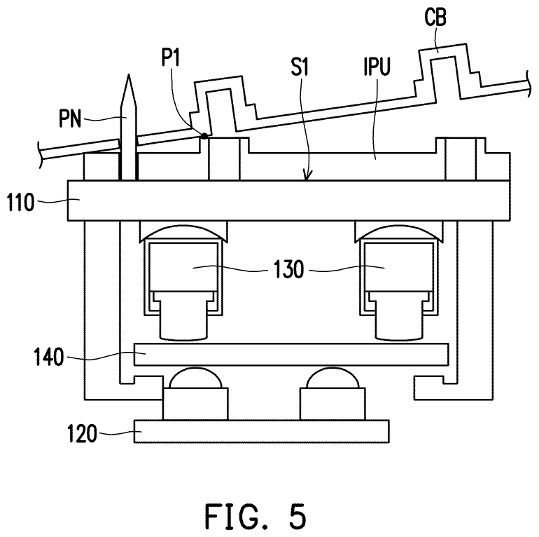

Furthermore, as shown in FIG. 5, in the present embodiment, when the lifting mechanism 120 causes the battery carrier tray 110 to rise, and the battery unit IPU or the battery carrier tray 110 contacts the vehicle body CB at the first position P1, air in at least the cylinder 130 close to the first position P1 is discharged. More specifically, in the present embodiment, the automotive battery lifting device 100 further includes a detection unit (not shown) for detecting whether contact occurs between the battery unit IPU or the battery carrier tray 110 and the vehicle body CB, and controls the discharge of air in the cylinder 130 based on the contact condition.

For example, when the detection unit detects that the battery unit IPU or the battery carrier tray 110 contacts the vehicle body CB at the first position P1, air in the cylinder 130 closest to the first position P1 is discharged, and as the battery carrier tray 110 is lifted by the lifting mechanism 120 and the battery unit IPU or the battery carrier tray 110 contacts the vehicle body CB, air in the cylinder 130 is compressed. In this manner, by discharging air from at least the cylinder 130 close to the first position P1 serving as the contact point, load increase is prevented, thereby reducing the load on the contact point, so that excessive load is not applied to the contact point between the vehicle body CB and the battery unit IPU, and the vehicle body CB and the battery unit IPU may be protected. Moreover, since air may be discharged without increasing pressure on the contact point, the load on the battery unit IPU may be reduced.

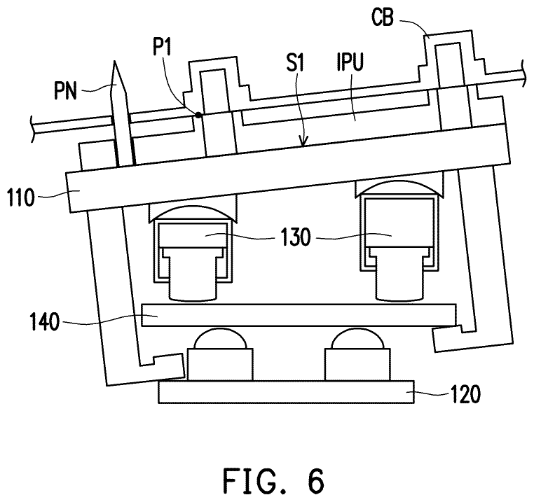

Moreover, as the battery unit IPU is lifted from the bottom side of the vehicle body CB, the battery unit IPU will sequentially contact the vehicle body CB in areas other than the first position P1, and in the present embodiment, as shown in FIG. 5 and FIG. 6, when the air pressure of all the plurality of cylinders 130 exceeds their set release pressure due to contact, the lifting mechanism 120 raises the battery carrier tray 110 until all the plurality of cylinders 130 are in an exhaust state. In the lifting step, the lifting mechanism 120 raises the battery carrier tray 110 until the air pressure of all the cylinders 130 exceeds their set release pressure, and all the plurality of cylinders 130 are in an exhaust state.

Furthermore, as shown in FIG. 7C, the cylinder 130 may adjust the horizontal inclination of the carrier surface S1 of the battery carrier tray 110 by adjusting the air pressure in the cylinder 130. For example, as shown in FIG. 6, FIG. 7B and FIG. 7C, by reducing the air pressure in the cylinder 130 close to the first position P1 as the contact point and increasing the air pressure in the cylinder 130 away from the first position P1 as the contact point, the height of the floating mechanism FL on the cylinder 130 may be changed, and thereby the horizontal inclination of the carrier surface S1 of the battery carrier tray 110 may be changed. Moreover, as shown in FIG. 8B and FIG. 8C, through control of the air pressure of cylinders 130 at different positions (cylinder 130A, cylinder 130B, cylinder 130C, cylinder 130D), the swing amplitude of the battery carrier tray 110 in different directions may be further controlled, thereby achieving control of the pitch angle (PITCH) and roll angle (ROLL) of the battery carrier tray 110 to control the inclination of the battery carrier tray 110 in all directions. In this manner, the carrier surface S1 for mounting battery unit IPU in the battery carrier tray 110 may be tilted, and furthermore, during the process when the battery unit IPU is lifted from the bottom side of the vehicle body CB and contacts the vehicle body CB, the automotive battery lifting device 100 may assemble the battery unit IPU in a manner that the carrier surface S1 of the battery carrier tray 110 tilts substantially parallel to the bottom surface of the vehicle body CB by controlling the air pressure in the cylinder 130 between the battery carrier tray 110 and the lifting mechanism 120. In this manner, excessive load on the vehicle body CB and lift generated by contact may be suppressed, and since the mounting surface of the battery unit IPU also tilts substantially parallel to the bottom surface of the vehicle body CB, axial force is not lost when fixing the battery unit IPU and the vehicle body CB, and the battery unit IPU may be more firmly fixed to the vehicle body CB. Thereby, through control of the air pressure in the cylinder 130, the automotive battery lifting device 100 may more rapidly change the inclination of the battery carrier tray 110, and may make the carrier surface S1 of the battery carrier tray 110, the mounting surface of the battery unit IPU, and the bottom surface of the vehicle body CB parallel, thereby improving the mounting speed of the battery unit IPU.

In this manner, the automotive battery lifting device 100 uses the pressure increased during contact as a trigger mechanism for whether to discharge air in the cylinder 130, and may prevent load increase through a simple configuration, thereby enabling reduction of the total load at contact points, further enabling protection of the battery unit IPU, and further enabling the lifting mechanism 120 to achieve overload capability for handling the load of the battery unit IPU, fixture weight, and reaction force of the floating mechanism FL, but without bearing loads exceeding necessary weight such as greater than the vehicle weight, preventing occurrence of overload abnormalities. Moreover, in the present embodiment, through the configuration of the cylinder 130 and the floating mechanism FL, the possibility of wear over time of other elastic components (such as springs) may be eliminated, and the floating force of the floating mechanism FL may be adjusted by changing the air pressure of the cylinder 130 according to changes in dimensions and weight of the battery unit IPU, enabling the vehicle body CB and the battery unit IPU to maintain close contact, further enabling the battery unit IPU to be firmly fixed on the vehicle body CB.

In summary, in the automotive battery lifting device of the embodiment of the present invention, the battery carrier tray for battery unit mounting and the lift that raises and lowers the battery carrier tray relative to the vehicle are supported by a cylinder. The cylinder performs assembly of the battery unit in a manner that tilts the carrier surface at a specified inclination relative to the bottom surface of the vehicle in response to contact between the battery unit or the battery carrier tray and the bottom surface of the vehicle. Here, the specified inclination refers to an inclination suitable for fixing the battery unit to the vehicle. Therefore, even when the vehicle is tilted, the battery unit may be easily assembled to the vehicle with a simple structure. Moreover, the automotive battery lifting device uses the pressure that increases upon contact as a trigger mechanism for whether to discharge air in the cylinder, and may prevent load increase through a simple configuration, thereby enabling reduction of the total load at contact points, and further enabling protection of the battery unit, and further enabling the lifting mechanism to achieve overload capability for handling the load of the battery unit, fixture weight, and reaction force of the floating mechanism, but without bearing loads exceeding necessary weight such as greater than the vehicle weight, preventing overload abnormality conditions from occurring. Furthermore, since the mounting surface of the battery unit and the bottom surface of the vehicle body also tilt in a substantially parallel manner, axial force is not lost when fixing the battery unit and vehicle body, and the battery unit may be more firmly fixed to the vehicle body. In addition, through control of air pressure in the cylinder, the automotive battery lifting device may more rapidly change the inclination of the battery carrier tray, thereby enabling improvement of the mounting speed of the battery unit.

Finally, it should be noted that the above embodiments are only used to illustrate the technical solutions of the present invention, and are not intended to limit them; although the present invention has been described in detail with reference to the aforementioned embodiments, those of ordinary skill in the art should understand that they may still modify the technical solutions described in the aforementioned embodiments, or make equivalent substitutions for some or all of the technical features thereof; and these modifications or substitutions do not cause the essence of the corresponding technical solutions to depart from the scope of the technical solutions of the embodiments of the present invention.

What is claimed is:

1. An automotive battery lifting device for assembling a battery unit to a vehicle body from a bottom surface side of the vehicle body, comprising:
a battery carrier tray having a carrier surface for mounting the battery unit;
a lifting mechanism for moving the battery carrier tray along a lifting direction; and
a plurality of cylinders for adjusting a horizontal inclination of the carrier surface of the battery carrier tray,
when the lifting mechanism raises the battery carrier tray, and the battery unit or the battery carrier tray contacts the vehicle body at a first position,
air in at least the cylinder close to the first position is discharged.

2. The automotive battery lifting device according to claim 1, wherein,
the battery carrier tray is supported by a support pressure set by each of the cylinders, and each of the cylinders is respectively set with a release pressure greater than the support pressure,
when air pressure in any of the cylinders reaches the set release pressure, discharge the air in any of the cylinders to make the air pressure in any of the cylinders below the set release pressure.

3. The automotive battery lifting device according to claim 2, wherein,
when air pressure of all of the plurality of cylinders exceeds the set release pressure due to contact,
the lifting mechanism raises the battery carrier tray until all of the plurality of cylinders are in an exhaust state.

4. The automotive battery lifting device according to claim 2, wherein,
a release pressure of the cylinder when the battery carrier tray is raised by the lifting mechanism is set to be lower than a release pressure of the cylinder before the battery carrier tray is raised by the lifting mechanism.

5. The automotive battery lifting device according to claim 1, further comprising:
detection unit, for detecting whether contact occurs between the battery unit or the battery carrier tray and the vehicle body,
based on a contact condition, control the discharge of air in the cylinder.

6. The automotive battery lifting device according to claim 1, further comprising:
sliding unit, disposed between the cylinders and the lifting mechanism,
the sliding unit enabling the battery unit and the battery carrier tray to slide in a direction perpendicular to the lifting direction.

7. The automotive battery lifting device according to claim 1, further comprising:
a locating pin, for fixing the battery unit on the carrier surface of the battery carrier tray,
wherein the battery carrier tray has a sliding mechanism capable of adjusting the locating pin on a plane perpendicular to the lifting direction.

8. A method for lifting an automotive battery, comprising:
a pressure setting step, setting a support pressure and a release pressure for a plurality of cylinders disposed between a battery carrier tray and a lifting mechanism and corresponding to a battery unit;
a battery support step, utilizing the support pressure to support the battery carrier tray having the battery unit mounted thereon;
a lifting step, utilizing the lifting mechanism to lift the battery carrier tray, and
in the lifting step,
the lifting mechanism raises the battery carrier tray until air pressure of all the cylinders exceeds the set release pressure, and all of the plurality of cylinders are in an exhaust state.
